(19) United States
(12) Patent Application Publication
(10) Pub. No.: US 2004/0102228 A1
(43) Pub. Date: May 27, 2004

(54) Communication apparatus, communication method, communication program, and recording medium

(76) Inventors: Koji Hakamata, Shizuoka (JP); Hirotsugu Matsuura, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/467,408

(22) PCT Filed: May 16, 2002
(86) PCT No.: PCT/JP02/04748

(30) Foreign Application Priority Data
Jul. 13, 2001 (JP) P. 2001-213464

(51) Int. Cl. H04M 1/00; H04B 1/38

(52) U.S. Cl. 455/572; 455/573

(57) ABSTRACT

The invention aims at providing communication apparatus, a communicating method, a communications program and a recording medium which allows the user to properly determine whether a target data group can be transceived thereby improving the convenience of the user and eliminating a drop in the use efficiency of communications circuits.

In order to accomplish the object, a battery level detector detects the level of the battery, a transceiving availability determining section obtains the remaining operating time up to shutdown of the communication apparatus due to exhaustion of the battery based on the level of the battery detected and obtains the amount of data which can be transceived by the communication apparatus before exhaustion of the battery based on the remaining operating time, and an operating state reporting section reports the amount of data which can be transceived.

### TECHNICAL FIELD

The present invention relates to communication apparatus driven by a battery, a communicating method for the apparatus, a communications program for executing the communicating method and a recording medium where the communications program is recorded, and in particular to communication apparatus, a communicating method, a communications program and a recording medium which can report the amount of data to be transceived or whether communications are available in order for the user to properly determine whether a target data group can be transceived, and in case a battery is exhausted during communications, improve the convenience of the user as well as prevent a drop in the use efficiency of communications circuits by recharging the battery, or reducing the communications data amount or current consumption, etc.

### BACKGROUND OF THE INVENTION

Conventionally, transceiving of documents and image data as well as voice communications have been ubiquitous on battery-driven communication apparatus, for example a cell phone and a portable information terminal. With expansion of functions, a hybrid of communication apparatus and various types of apparatus and miniaturization of apparatus have been examined. While the operating time of battery-driven communication apparatus is limited due to its battery-driven system, the user has estimated the remaining operating time of the communication apparatus up to exhaustion of the battery in broad time units based on the battery power indication provided in several steps on the indicator of the communication apparatus.

The user estimates the remaining operating time of the related art communication apparatus up to exhaustion of the battery only in broad time units. Thus the user does not know precisely whether a target data group such as files can be completely transceived before the battery gets exhausted. There have been cases where communications are interrupted because the battery is exhausted during data communications. In such a case, the data group transceived halfway is useless on the part of a receiving party in most cases. The data group has to be transceived from the beginning after the battery has been recharged. This lowers the use efficiency of communications circuits.

The present invention has been accomplished in view of the related art circumstances and aims at providing communication apparatus, a communicating method, a communications program and a recording medium which can report the amount of data to be transceived according to the remaining operating time of the communication apparatus up to exhaustion of a battery in order for the user to properly determine whether a target data group can be transceived.

Another object of the invention is to provide communication apparatus, a communicating method, a communications program, and a recording medium which can determine whether a target data group can be transceived before the battery is exhausted and report the result of determination to the user for the convenience of the user.

Another object of the invention is to provide communication apparatus, a communicating method, a communications program and a recording medium which prevent communications by recharging the battery, or reducing the communications data amount or current consumption, etc., in case the battery gets exhausted during data communications thereby eliminating the user's workload and a drop in the use efficiency of communications circuits caused by retried communications of a target data group.

### DISCLOSURE OF THE INVENTION

In order to solve the aforementioned problems, communication apparatus according to a first aspect of the invention is communication apparatus driven by a battery, wherein the communication apparatus comprises battery level detecting means for detecting the level of the battery, transceiving availability determining means for obtaining the remaining operating time up to shutdown of the communication apparatus due to exhaustion of the battery based on the level of the battery detected by the battery level detecting means and obtaining the amount of data which can be transceived by the communication apparatus before exhaustion of the battery based on the remaining operating time, and reporting means for reporting the amount of data which can be transceived.

A communication apparatus according to a second aspect of the invention is communication apparatus according to the first aspect of the invention, wherein the transceiving availability determining means determines whether a target data group can be transceived before exhaustion of the battery based on the amount of data which can be transceived in sending or receiving data and the reporting means reports the determined result of the transceiving availability by the transceiving availability determining means.

A communication apparatus according to a third aspect of the invention is communication apparatus according to the first aspect of the invention, wherein the transceiving availability determining means obtains the amount of data which can be transceived during transmission or reception of a target data group and the reporting means reports the progress of the transmission or reception procedure and the amount of data which can be transceived.

A communication apparatus according to a fourth aspect of the invention is communication apparatus according to the first, second or third aspect of the invention, wherein the communication apparatus comprises communications control means for suspending communications when the transceiving availability determining means has determined that a target data group cannot be transceived before exhaustion of the battery based on the amount of data which can be transceived and the reporting means reports that communications will be suspended and the reason for suspension.

A communication apparatus according to a fifth aspect of the invention is communication apparatus according to the first, second, third or fourth aspect of the invention, wherein the transceiving availability determining means starts recharging of the battery and obtains the amount of data which can be transceived during recharging and the reporting means reports the amount of data which can be transceived when it has determined that a target data group cannot be transceived before exhaustion of the battery based on the amount of data which can be transceived.

A communication apparatus according to a sixth aspect of the invention is communication apparatus according to the fifth aspect of the invention, wherein the communication apparatus comprises storage means for retaining as a charging characteristics correction table the variations in the charging amount caused by the ambient temperature of the communication apparatus during recharging of the battery and the transceiving availability determining means references the charging characteristics correction table to perform temperature-based correction of the remaining operating time.

A communicating method according to a seventh aspect of the invention is a communicating method for communication apparatus driven by a battery, wherein the method comprises a battery level detecting step of detecting the level of the battery, a remaining operating time detecting step of detecting a remaining operating time up to shutdown of the communication apparatus due to exhaustion of the battery based on the level of the battery detected by the battery level detecting step, a communicable data amount detecting step of obtaining the amount of data which can be transceived by the communication apparatus before exhaustion of the battery based on the remaining operating time, and a reporting step of reporting the amount of data which can be transceived.

A communications program according to an eighth aspect of the invention is a program used to instruct a computer to execute the communicating method according to the seventh aspect of the invention.

A computer-readable recording medium according to a ninth aspect of the invention is recorded as a program used to instruct a computer to execute the communicating method according to the seventh aspect of the invention.

In the communication apparatus according to the first aspect of the invention, the communicating method according to the seventh aspect of the invention, the communications program according to the eighth aspect of the invention and the recording medium according to the ninth aspect of the invention, the battery level detecting means (battery level detecting step) detects the level of a battery, the transceiving availability determining means obtains (by way of the remaining operating time detecting step) the remaining operating time up to shutdown of the communication apparatus due to exhaustion of the battery based on the level of the battery detected, and obtains (by way of the communicable data amount detecting step) the amount of data which can be transceived by the communication apparatus before exhaustion of the battery based on the remaining operating time, and the reporting means (reporting step) reports to the user the amount of data which can be transceived based on the remaining operating time. This makes it possible to allow the user to properly determine whether a target data group can be transceived.

In the communication apparatus according to the second aspect of the invention, the transceiving availability determining means determines whether a target data group can be transceived before exhaustion of the battery based on the amount of data which can be transceived in sending or receiving data and the reporting means reports the determined result of transceiving availability. In this way, the determined result of transceiving availability of a target data group which is based on the amount of data which can be transceived is reported to the user. This avoids an interruption of data communications due to exhaustion of a battery thereby eliminating the user's workload and a drop in the use efficiency of communications circuits caused by retried communications of a target data group.

In the communication apparatus according to the second aspect of the invention, the transceiving availability determining means determines whether a target data group can be transceived before exhaustion of the battery based on the amount of data which can be transceived in sending or receiving data and the reporting means reports the determined result of transceiving availability. In this way, the determined result of transceiving availability of a target data group is reported to the user thus avoiding an interruption of data communications due to exhaustion of a battery, thereby eliminating the user's workload and a drop in the use efficiency of communications circuits caused by retried communications of a target data group.

In the communication apparatus according to the third aspect of the invention, the transceiving availability determining means obtains the amount of data which can be transceived during transmission or reception of a target data group and the reporting means reports the progress of the transmission or reception procedure and the amount of data which can be transceived. In this way, the progress of the transmission or reception procedure and the amount of data which can be transceived are reported to the user as required for the user to properly determine whether the target data group can be transceived thus improving the convenience of the user.

In the communication apparatus according to the fourth aspect of the invention, the communications control means suspends communications and the reporting means reports that communications will be suspended and the reason for suspension when the transceiving availability determining means has determined that a target data group cannot be transceived before exhaustion of the battery based on the amount of data which can be transceived. By suspending communications before communicating the target data group, it is possible to avoid an interruption of data communications due to exhaustion of a battery thereby eliminating the user's workload and a drop in the use efficiency of communications circuits caused by retried communications of the target data group.

In the communication apparatus according to the fifth aspect of the invention, the charging means starts recharging of the battery when the transceiving availability determining means has determined that a target data group cannot be transceived before exhaustion of the battery based on the amount of data which can be transceived. The transceiving availability determining means obtains the amount of data which can be transceived during recharging and the reporting means reports the amount of data which can be transceived. In this way, the battery is recharged to allow communications when it is determined that the target data group cannot be transceived. This avoids an interruption of data communications due to exhaustion of a battery thereby eliminating the user's workload and a drop in the use efficiency of communications circuits caused by retried communications of the target data group. The amount of data which can be transceived is reported to the user as required during recharging. This improves the convenience of the user.

In the communication apparatus according to the sixth aspect of the invention, the storage means retains as a charging characteristics correction table the variations in the charging amount caused by the ambient temperature of the communication apparatus during recharging of the battery and the transceiving availability determining means references the charging characteristics correction table to perform temperature-based correction of the remaining operating time. This allows the more precise amount of data which can be transceived to be obtained.

### BRIEF DESCRIPTION OF THE DRAWINGS

FIG. 1 is a block diagram of communication apparatus according to an embodiment of the invention;

FIG. 2 is a first flowchart explaining the operation of the communication apparatus according to the embodiment.

FIG. 3 is a second flowchart explaining the operation of the communication apparatus according to the embodiment.

FIG. 4 is a third flowchart explaining the operation of the communication apparatus according to the embodiment.

FIG. 5 is a fourth flowchart explaining the operation of the communication apparatus according to the embodiment.

FIG. 6 is a flowchart of a subroutine for obtaining a remaining operating time R1 up to exhaustion of a battery.

In the figures, a numeral or sign 100 represents communication apparatus, 101 an antenna, 102 a charger, 102 a power source, 104 a battery, 105 a storage section, TB1 a discharge characteristics table, TB2 a charging characteristics table, TB3 a specifications table, 106 a battery level detector, 107 a transceiving availability determining section, 108 a communications controller, 109 an operating state reporting section, 110 a data processor (data compression means), 111 a transmitter, and 112 a receiver.

### BEST MODE FOR CARRYING OUT THE INVENTION

An embodiment of communication apparatus, a communicating method, a communications program and a recording media according to the invention will be described in detail referring to the drawings. In the following description of the embodiment, the communication apparatus and the communicating method according to the invention are detailed. The communications program according to the invention is a program used to execute the communicating method and the recording medium according to the invention is a recording medium where the program to execute the communicating method is recorded. Thus description of the communications program and the recording medium is included in the following description of the communicating method.

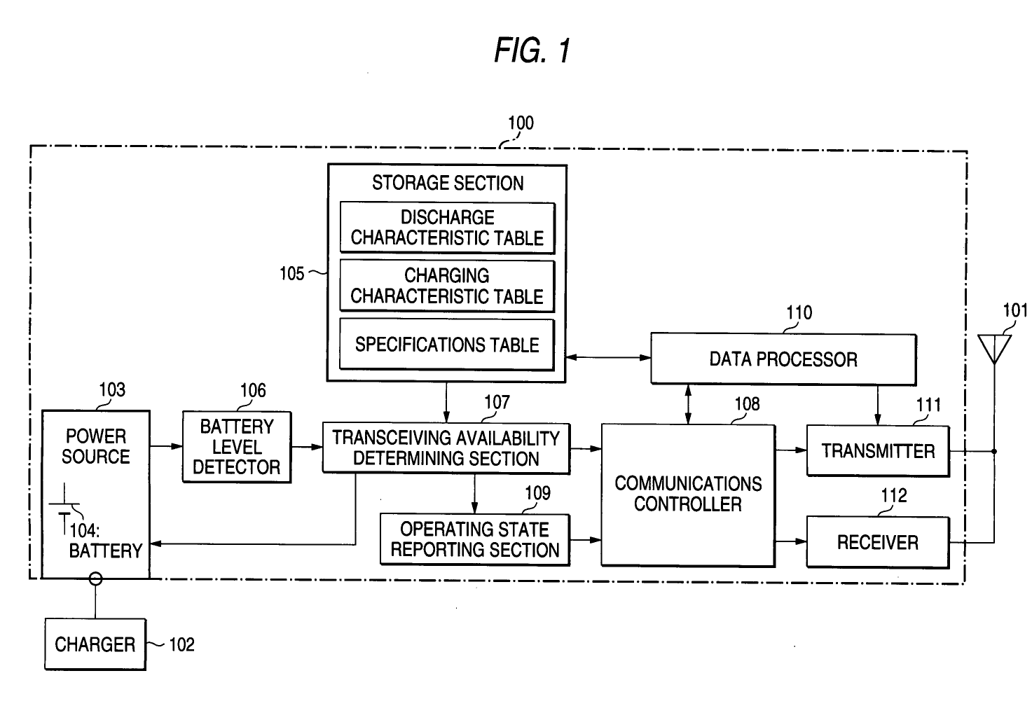

FIG. 1 is a block diagram of communication apparatus according to an embodiment of the invention. This embodiment describes a cell phone or a portable information terminal as a specific example of communication apparatus. A battery to drive the apparatus may be a rechargeable battery 104 such as a nickel-cadmium battery, nickel metal hydride battery or a lithium-ion secondary battery, although other batteries may be used instead.

In FIG. 1, communication apparatus of the embodiment comprises a power source 103 including a battery 104, a storage section 105 including a discharge characteristics table TB1, a charging characteristics table TB2 and a specifications table TB3, a battery level detector 106, a transceiving availability determining section 107, a communications controller 108, an operating state reporting section 109, a data processor 110, a transmitter 111, a receiver 112 and an antenna 101. A charger 102 may be connected to the communication apparatus via a charging terminal. The transceiving availability determining section 107, the communications controller 108 and the data processor 110 are implemented by a microprocessor (MPU, CPU) or a digital signal processor (DSP), etc.

The transmitter 111, the receiver 112 and the antenna 101 are same as those provided on general communication apparatus and has no special features, so that the corresponding description is omitted. The operating state reporting section 109 reports the operating state of the communication apparatus 100 to the user and is implemented by an LCD panel or a speaker, etc. The communication apparatus comprises a ten-key pad and a microphone as input means for accepting user's instruction and voice input although they are not shown in FIG. 1.

The storage section 105 is implemented by a volatile or nonvolatile semiconductor memory (RAM, ROM, EEPROM, or flash memory), etc. In a predetermined area of the storage section 105 are retained the discharge characteristics table TB1, the charging characteristics table TB2 and the specifications table TB3.

The discharge characteristics table TB1 shows the variation in the battery voltage of the battery 104 in time or discharge characteristics of the battery 104 per current consumption. As mentioned later, the transceiving availability determining section 107 can obtain the remaining operating time R1 of the communication apparatus 100 up to exhaustion of the battery by referencing the discharge characteristics table TB1 based on the battery voltage and current consumption detected by the battery level detector 106. By reflecting the discharge characteristics per ambient temperature in the discharge characteristics table TB1, it is possible to obtain the remaining operating time R1 of the communication apparatus 100 dependent on the ambient temperature of the operating environment, thus allowing temperature-based correction of an amount of data R3 capable of being transceived described later.

The charging characteristics table TB2 shows the charging amount or level of a battery dependent on the charging time from start of recharging or battery voltage of the battery 100, or charging characteristics of the battery 104. As described later, the transceiving availability determining section 107 can obtain the remaining operating time R1 of the communication apparatus 100 during or after recharging up to exhaustion of the battery by referencing the charging characteristics table TB2 and the discharge characteristics table TB1 based on the battery voltage, charging time and current consumption detected by the battery level detector 106. By reflecting the discharge characteristics per ambient temperature in the charging characteristics table TB2, it is possible to obtain the remaining operating time R1 of the communication apparatus 100 dependent on the ambient temperature of the operating environment, thus allowing temperature-based correction of an amount of data R3 capable of being transceived described later.

The specifications table TB3 is a table which describes the current consumption and transfer speed of the communication apparatus per communications circuit and communications system used. The communications system includes a variety of communications systems such as the FDD system (frequency division duplex) and TDD system (time division duplex). The current consumption and the transfer speed as previously set per communications system supported by the communication apparatus 100. The current consumption of the communication apparatus 100 slightly differs depending on data transmission or reception and which of the auxiliary storage devices external to the communication apparatus 100 such as a floppy disk and a memory card is used as a storage location of transceived data. Thus it is desirable to previously describe the current consumption per operation type in order to obtain a precise remaining operating time R1. The current consumption data per operation type is unnecessary for a case where current consumption is directly detected by the battery level detector 106 described later.

The battery level detector 106 detects the level or battery voltage of the battery 104. Detection of the battery voltage may use any circuit configuration. A circuit for detecting currents in charging control (for example detection of a charging start/end current) is required. This circuit may be used for direct detection of current consumption.

The transceiving availability determining section 107 obtains the remaining operating time R1 of the communication apparatus 100 up to shutdown of the communication apparatus 100 caused by exhaustion of the battery 104 by referencing the charging characteristics table B1 based on the remaining battery level detected by the battery level detector 106 and the current consumption per operation type obtained through reference to the specifications table TB3 (or direct detection by the battery level detector 106). It is possible to obtain the remaining operating time which has undergone temperature-based correction depending on the ambient temperature of the operating environment of the communication apparatus 100 by referencing the discharge characteristics per ambient temperature in the discharge characteristics table TB1.

The transceiving availability determining section 107 then references the specifications table TB3 to obtain the data transfer speed R2 of the communication apparatus 100 from the currently used communications circuit and communications system and obtain the amount of data R3 which can be transceived by the communication apparatus 100 before exhaustion of the battery 104 from “remaining operating time R1×data transfer speed R2.” The transceiving availability determining section 107 reports the amount of data R3 capable of being transceived to the user via an operating state reporting section 109. In case total data amount or amount of remaining data is known for a target file, etc., it is possible to determine whether the target file can be transceived before shutdown of the communication apparatus 100 due to exhaustion of the battery 104, by checking whether the data amount is greater than the amount of data R3 capable of being transceived. In this practice, the determined result of availability of transceiving file is reported to the user via the operating state reporting section 109.

The data processor 110 performs data processing on a target file, etc. In this embodiment, the data processor 110 comprises a function to perform data compression based on an instruction from the communications controller 108.

The communications controller 108 performs a variety of operation control described below based on a user's instruction or a preset procedure when the transceiving availability determining section 107 has determined that the target file, etc, cannot be transceived.

The first operation control is suspension of communication. In case the level of the battery 104 is low and the total amount of a file, etc. or amount of remaining data is considerably greater than the amount of data R3 capable of being transceived, the communications controller 108 suspends communications based on a user's instruction or automatically. The communications controller 108 may ask the user whether to suspend communications via the operating state reporting section 109 or automatically suspend communications and report the reason for suspension to the user via the operating state reporting section 109.

The second operation control is data compression of a target file, etc. followed by communications of the resulting file. In the case of data transmission, the communications controller 108 performs data compression of a target file on a data processor 110 and sends the resulting file via a transmitter 111. In the case of data reception, the communications controller 108 requests via the transmitter 111 the party sending a target file to send the data-compressed file. The second operation control may be performed based of a user's instruction for example on a display including the determined result of transceiving availability of the file as well as screen for selecting a data compression system. Or, a data compression system may be automatically selected based on the comparison of data amount with the amount of data R3 capable of being transceived. In case the compressed data amount is smaller than the amount of data R3 capable of being transceived, the communications controller 108 automatically starts communications. In case the compressed data amount stays greater than the amount of data R3 capable of being transceived, the communications controller 108 proceeds to another operation control.

The third operation control is recharging of the battery 104. In case the level of the battery 104 is low and the total amount of a file, etc. or amount of remaining data is considerably greater than the amount of data R3 capable of being transceived, the communications controller 108 starts recharging the battery 104 based on a user's instruction. That is, the communications controller 108 prompts via the operating state reporting section 109 the user to recharge the battery 104. The user places the communication apparatus 100 on a charger 102 to start recharging the battery 104. The communications controller 108 cyclically obtains on the transceiving availability determining section 107 the amount of data R3 capable of being transceived during recharging of the battery 104, and reports the updated amount of data R3 capable of being transceived to the user via the operating state reporting section 109 as required. The communications controller 108 may reference the charging characteristics per ambient temperature in the charging characteristics table TB2 in obtaining the remaining operating time R1 to use the remaining operating time R1 which has undergone temperature correction depending on the ambient temperature of the use environment of the communication apparatus 100.

The third operation control is reduction of transmitting power. Reduction of transmitting power is made for example by way of APC in a power amplifier circuit or AGC in a variable gain amplifier circuit in the transmitter 111. Adjustment of power or gain is made considering the increase in the amount of data R3 capable of being transceived caused by reduction of current consumption while comparing the data amount with the amount of data R3 capable of being transceived. Depending on the use environment of the communication apparatus 100, the transmitting power cannot be reduced, so that the communications controller 108 may ask the user whether to reduce the transmitting power via the operating state reporting section 109. In case the data amount is smaller than the amount of data R3 capable of being transceived due to an increase in the amount of data which can be transceived due to reduction of transmitting power, the communications controller 108 automatically starts communications while in case the data amount does not lower the amount of data R3 capable of being transceived despite the reduction of transmitting power, the communications controller 108 proceeds to another operation control. This operation control may be performed based of a user's instruction for example on a display including the determined result of transceiving availability of file as well as screen for selecting a communications system. Or, a communications system may be automatically selected based on the comparison of data amount with the amount of data R3 capable of being transceived. In case a plurality of communications systems feature the minimum current consumption, a communications system with the highest transfer speed is selected. In case the data amount is smaller than the amount of data R3 capable of being transceived due to an increase in the amount of data R3 capable of being transceived by the selection of a communications system, the communications controller 108 automatically starts communications. In case the data amount stays greater than the amount of data R3 capable of being transceived despite selection of a communications system, the communications controller 108 proceeds to another operation control.

When the transceiving availability determining section 107 has determined that the total data of a target file, etc. cannot be transceived during communications, the communications controller suspends the communications, performs data compression of a target file, etc. (second operation control), recharging of the battery (third operation control), reduction of transmitting power (fourth operation control) or selection of a communications system with the minimum current consumption (fifth operation control), and restarts communications. In the case of data transmission, the communications controller 108 sends to a destination for example a message reporting that data transmission will be suspended before suspending data transmission and a message reporting that data transmission will be restarted before restarting data transmission. In the case of data reception, the communications controller 108 must store the data group received so far as a first file before suspending data reception and store the data received after restart of data reception as a second file, then follow the post-processing to combine the first and the second files.

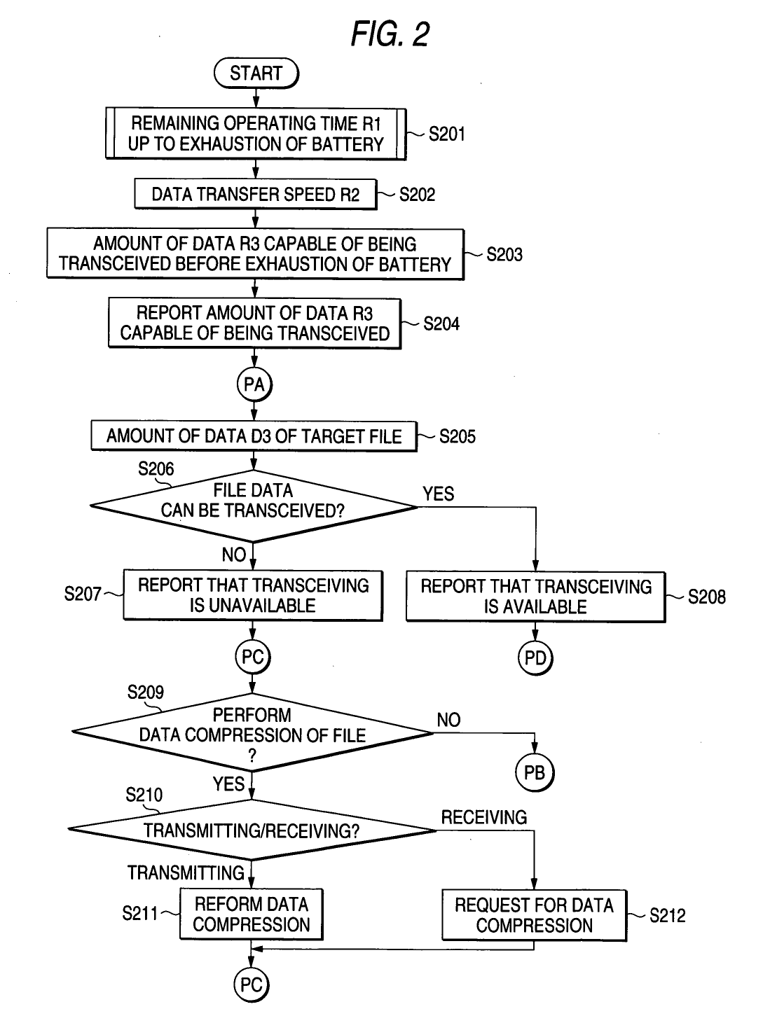

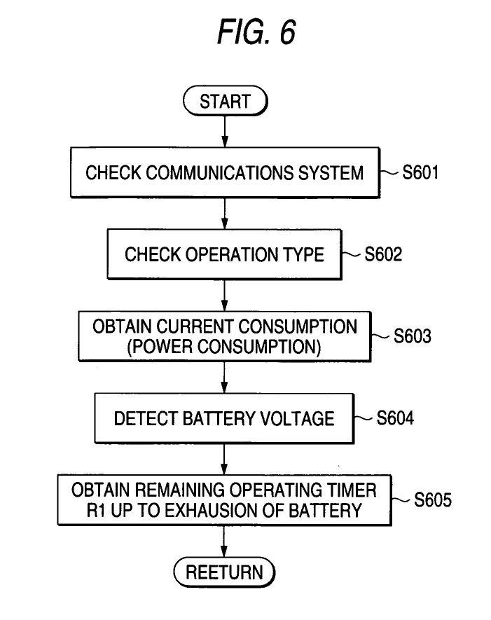

The operation (communications system) of the communication apparatus of the embodiment arranged as mentioned earlier will be described referring to FIGS. 2 through 6. FIGS. 2 through 5 are flowcharts of the operation of the communication apparatus of this embodiment (first to fourth flowcharts) and FIG. 6 is a flowchart of a subroutine to obtain the remaining operating time R1 up to exhaustion of the battery.

In FIG. 2, the transceiving availability determining section 107 calls the subroutine in FIG. 6 to obtain the remaining operating time R1 up to exhaustion of the battery in step S201.

The remaining operating time R1 up to exhaustion of the battery is obtained as follows. In FIG. 6, the transceiving availability determining section 107 checks the communications system used by the communication apparatus 100 in step 601 and checks the operation type in step S602. In step S603, the transceiving availability determining section 107 references the specifications table TB3 to obtain the current consumption to suit the communications system and the operation type. In step S604, the transceiving availability determining section 107 obtains the battery level (battery voltage). In step S606, the transceiving availability determining section 107 references the discharge characteristics table TB1 to obtain the remaining operating time R1 up to shutdown of the communication apparatus due to exhaustion of the battery based on the current consumption and battery level (battery voltage).

It is possible to obtain the remaining operating time R1 which has undergone temperature-based correction depending on the ambient temperature of the operating environment of the communication apparatus 100 by referencing the discharge characteristics per ambient temperature in the discharge characteristics table TB1. In step S603, the current consumption may be obtained through direct detection by the battery level detector 106.

Referring to FIG. 2 again, the transceiving availability determining section 107 references the specifications table TB3 to obtain the data transfer speed of the communication apparatus 100 from the currently used communications circuit and communications system in step S202. The transceiving availability determining section 107 obtains the amount of data R3 which can be transceived by the communication apparatus 100 before exhaustion of the battery 104 from “remaining operating time R1×data transfer speed R2” in step S203. The amount of data R3 obtained is reported to the user via the operating state reporting section 109 in step S204.

In step S205, the transceiving availability determining section 107 obtains a total amount of the target file data D3. In the case of data transmission, the transceiving availability determining section 107 obtains the total data amount of the file to be sent. In the case of data reception, the transceiving availability determining section 107 obtains the total data amount of the file to be received based on a transmission command sent from the sending party via the receiver 112.

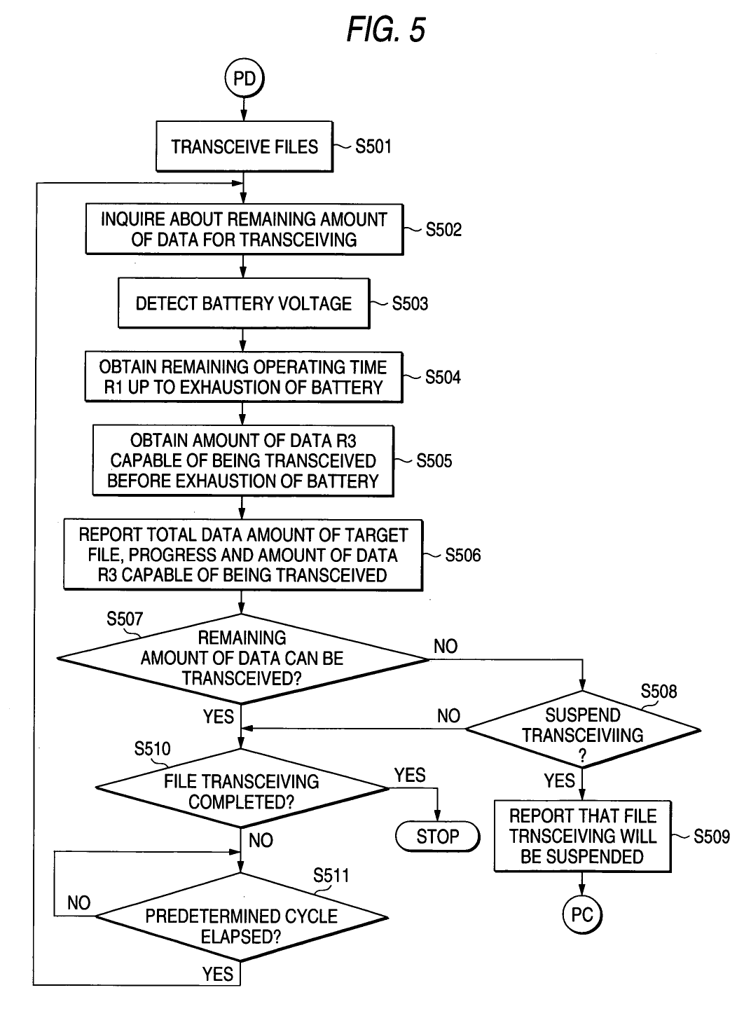

In step S206, the transceiving availability determining section 107 compares the total target file data amount D3 with the amount of data R3 capable of being transceived and determines whether the total data of the target file can be transceived. In case the total data amount D3 is smaller than the amount of data R3 capable of being transceived, the file can be transceived before shutdown of the communication apparatus 100 due to exhaustion of the battery 104. In step S208, a message reporting that the file can be transceived is sent to the user via the operating state reporting section 109. Execution then proceeds to step S501 (file communications) in FIG. 5. In case the total target file data amount D3 is greater than the amount of data R3 capable of being transceived in step S206, the file cannot be transceived. In this case, a message reporting that the file cannot be transceived is sent to the user. Execution then proceeds to step S209 (operation control).

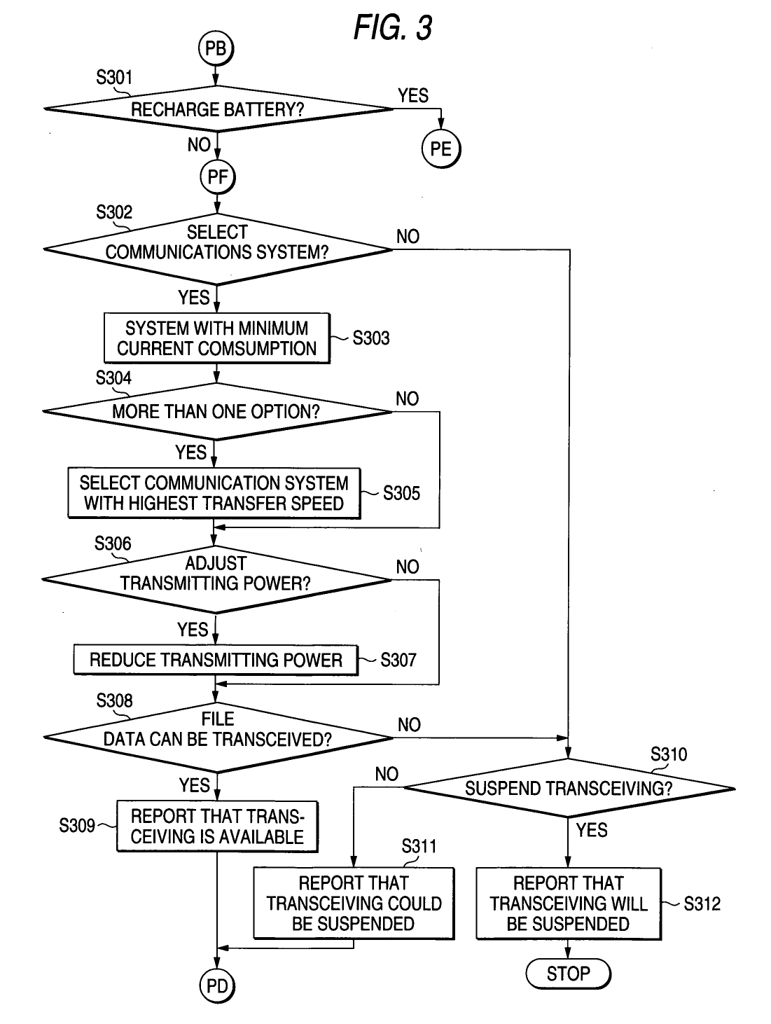

In step S209, the transceiving availability determining section 107 determined whether to perform data compression of the file to be transceived. This determination may be made by an instruction of a user prompted together with a message reporting that the file cannot be transceived in step S207, or automatically made by the communications controller 108 based on the comparison of the amount of data R3 capable of being transceived and the data amount of the file to be transceived. A data compression system may be selected by the user on a selection screen displayed. In case data compression is mot made on the file in step S209, execution proceeds to step S301 in FIG. 3 to start another operation control.

In case it is determined that the file will undergo data compression in step S209, execution proceeds to step S210 to determine which of data transmission or reception is to be performed. In the case of data transmission, execution proceeds to step S211 where the data processor 110 performs data compression of the file to be sent and the transmitter 111 sends the file. In the case of data reception, execution proceeds to step S212 where a request is issued via the transmitter 111 to the party sending the file to be received so that the file will be data-compressed before it is sent. In step S205 again, the target file data amount D3 is acquired. In step S206, it is determined whether the total data of the target file can be transceived.

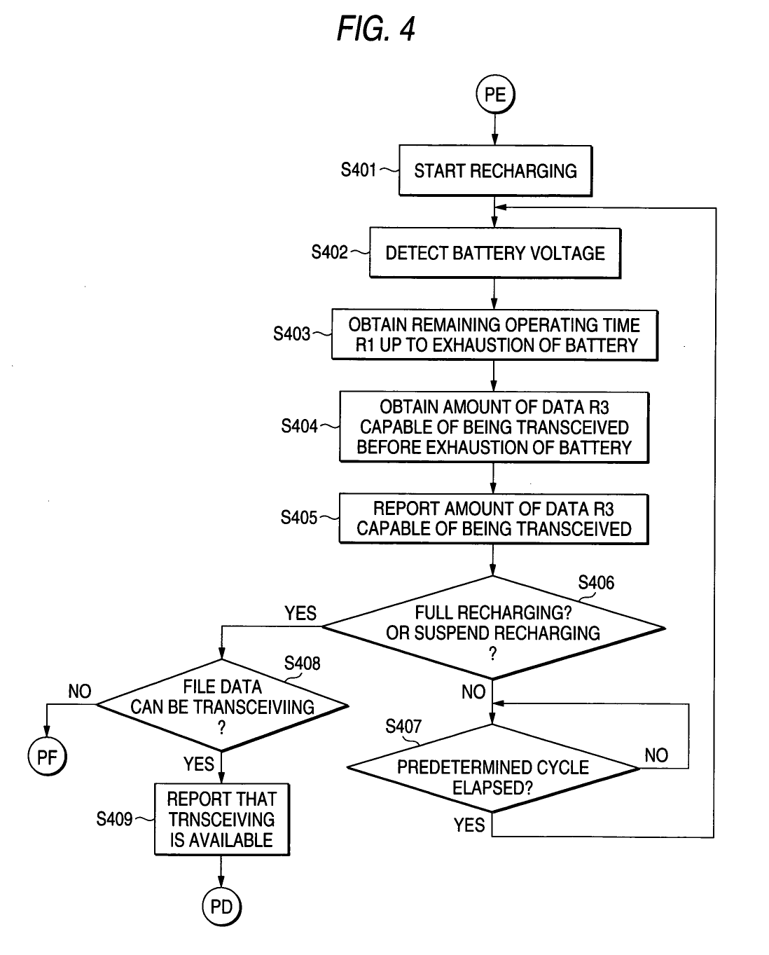

In FIG. 3, it is determined whether to recharge the battery 104 in step S301. The user is asked to determine whether to recharge the battery 104 via the operating state reporting section 109. When the user places the communication apparatus 100 on the charger 102, execution proceeds to step S401 in FIG. 4, where recharging of the battery 104 starts. To skip recharging of the battery 104, execution proceeds to step S302 where another operation control is executed.

In FIG. 4, once recharging of the battery 104 is started in step S401, processing of steps S402 through S407 (update and reporting of the amount of data R3 capable of being transceived) is repeated per predetermined cycle.

In step S403, the battery level (battery voltage) is obtained from the battery level detector 106. In step S403, the remaining operating time R1 up to exhaustion of the battery 104 is obtained by referencing the charging characteristics table TB2 and the specifications table TB3 based on the battery voltage, charging time and current consumption detected by the battery level detector 106. In step S404, the amount of data R3 capable of being transceived before exhaustion of the battery 104 is updated from “remaining operating time R1×data transfer speed R2.” The updated amount of data R3 capable of being transceived is reported to the user via the operating state reporting section 109. In obtaining the remaining operating time R1, it is possible to update the amount of data which can be transceived R2 by using the remaining operating time R1 which has undergone temperature-based correction depending on the ambient temperature of the use environment of the communication apparatus 100, by referencing the charging characteristics per ambient temperature in the charging characteristics table TB2.

In step S406, it is determined whether the recharging is complete or there is an instruction of the user to abort recharging (the communication apparatus 100 is removed from the charger 102). When this is the case, recharging is terminated and execution proceeds to step S408. Otherwise execution proceeds to step S407 where processing waits for a predetermined cycle to elapse.

Once the battery has been recharged, the total target file data amount D3 is compared with the amount of data R3 capable of being transceived to determine whether the target file can be transceived in step S408. In case communications of the target file are available, a message reporting that communications are available is sent to the user via the operating state reporting section 109 in step S409. Execution then proceeds to step S501 (file communications) in FIG. 5. In case communications are determined unavailable in step S408, execution proceeds to step S302 in FIG. 3 in step S207 to proceed to another operation control.

Returning to FIG. 3, whether to select a communications system is determined. This operation control may be performed based of a user's instruction for example on a display including the determined result of transceiving availability of file as well as screen for selecting a communications system. Or, a communications system may be automatically selected based on the comparison of the target file data amount D3 with the amount of data R3 capable of being transceived. In case selection of a communications system is skipped, execution proceeds to step S310 where another operation control is made.

In step S303, a communications system with the minimum current consumption is selected. In case In case a plurality of communications systems feature the minimum current consumption in step S304, a communications system with the highest transfer speed is selected in step S305.

In step S306, whether to adjust the transmitting power is determined. In case the transmitting power is to be adjusted, the transmitting power is reduced in step S307. Determination on whether to adjust the transmitting power may be automatically made based on the comparison of the amount of data R3 capable of being transceived with the file data amount D3 or the user may be asked via the operating state reporting section 109 to determine whether to reduce the transmitting power.

The amount of data R3 capable of being transceived has been increased due to selection of a communications system and reduction of transmitting power. Thus the target file data amount D3 is compared with the R3 again to determine whether the target file can be transceived in step S308. In case the file can be transceived, a message reporting that the file can be transceived is sent to the user via the operating state reporting section 109 in step S309. Execution then proceeds to step S501 (file communications) in FIG. 5. In case the file cannot be transceived in step S308, execution proceeds to step S301 where another operation control is executed. A determining step similar to step S308 may be inserted before step S306 to determine whether communications of the file have become available only due to an increase in the amount of data R3 capable of being transceived caused by selection of a communications system.

In step S310, whether to suspend communications is determined. The user may be asked via the operating state reporting section 109 to determine whether to suspend communications, or suspension of communications may be automatically determined based on the comparison of the target file data amount D3 with the amount of data R3 capable of being transceived. In case communications are not suspended, a message reporting that communications will be (or could be) suspended is sent to the user via the operating state reporting section 109. Then execution proceeds to step S510 (file communications) in FIG. 5. In case communications are suspended in step S310, a message reporting that communications will be suspended is sent to the user together with the reason for suspension in step S312, and processing is terminated.

Next, in FIG. 5, file communications start in step S501. During data communications, processing of steps S502 through S511 (update and reporting of the amount of data R3 capable of being transceived) is repeated per predetermined cycle.

In step S502, an inquiry is made about the remaining data amounts to the data processor 119 for data transmission and to the sending party of a received file for data reception, respectively. In step S503, the battery level (battery voltage) is obtained from the battery level detector 106. In step S504, the remaining operating time R1 up to exhaustion of the battery 104 based on the current consumption and the battery level (battery voltage) by referencing the discharge characteristics table TB1. In step S505, the amount of data R3 capable of being transceived before exhaustion of the battery 104 is updated from “remaining operating time R1×data transfer speed R2.” The updated amount of data R3 capable of being transceived is reported to the user via the operating state reporting section 109 together with the total data amount of the target file and the progress of the communications procedure (remaining data, etc.) in step S405.

In step S507, the remaining data amount of the target file is compared with the amount of data R3 capable of being transceived to determine whether the remaining data of the target file can be transceived. In case the data cannot be transceived, it is determined whether communications are suspended in step S508. The user is asked to determine whether to suspend communications via the operating state reporting section 109, or determination on suspension of communications is automatically made based on the result of comparison of the target file data amount D3 with the amount of data R3 capable of being transceived. In case communications are not suspended, execution proceeds to step S510. In case communications are suspended, a message reporting that communications will be suspended is sent together with the reason for the suspension to the user in step S509. Then execution proceeds to step S209 in FIG. 2.

In case communications are determined available in step S507 or in case communications are not to be suspended although communications are determined unavailable in step S507, whether to terminate file communications is determined in step S510, and processing waits for a predetermined cycle to elapse in step S511.

In the communicating method of this embodiment, the operation control assumed when the transceiving availability determining section 107 has determined that all the data of a target file, etc. cannot be communications is made in the order: data compression of a target file (second operation control: steps S209-S212); recharging of a battery (third operation control: steps S301, S401-S409); selection of a communications system (fifth operation control: steps S302-S305); reduction of transmitting power (fourth operation control: steps S306-S309); and suspension of communications (first operation control: steps S310-S312). The invention is not limited to this order but the order may be changed so as to perform more efficient operation control depending on the configuration, features and applications of communication apparatus.

As mentioned hereinabove, in the communication apparatus and the communicating method of this embodiment, the battery level detector 106 detects the battery level, the transceiving availability determining section 107 obtains the remaining operating time R1 of the communication apparatus 100 up to shutdown of the communication apparatus caused by exhaustion of the battery based on the detected battery level. The communication apparatus 100 then obtains the amount of data R3 capable of being transceived before exhaustion of the battery 104 based on the remaining operating time R1 and the operating state reporting section 109 reports the amount of data R3 capable of being transceived. This allows the user to properly determine whether a target file, etc. can be transceived. The transceiving availability determining section 107 references the discharge characteristics table TB1 in the storage section 105 and performs temperature-based correction of the remaining operating time R1. This obtains a more precise amount of data R3 capable of being transceived.

In this embodiment, the transceiving availability determining section 107 determines whether the target file, etc. can be transceived before exhaustion of the battery 104 based on the amount of data R3 capable of being transceived before data transmission or reception and the operating state reporting section 109 reports the determined result of transceiving availability. This avoids an interruption of data communications due to exhaustion of a battery thereby eliminating the user's workload and a drop in the use efficiency of communications circuits caused by retried communications of a data group.

In this embodiment, the transceiving availability determining section 107 cyclically obtains the amount of data R3 capable of being transceived during transmission or reception of a target file, etc. and the operating state reporting section 109 reports to the user the progress of the transmission or reception procedure and the amount of data R3 capable of being transceived as required. This allows the user to properly determine whether the target data group can be transceived thus improving the convenience of the user.

In this embodiment, the communications controller 108 suspends communications and the operating state reporting section 109 reports that communications will be suspended and the reason for suspension when the transceiving availability determining section 107 has determined that a target data group cannot be transceived before exhaustion of the battery 104 based on the amount of data R3 capable of being transceived. By suspending communications before communications, it is possible to avoid an interruption of data communications due to exhaustion of a battery thereby eliminating the user's workload and a drop in the use efficiency of communications circuits caused by retried communications of the target data group.

In this embodiment, the communications controller 108 performs data compression of a target file, etc. on a data processor 110 and sends the resulting data group when the transceiving availability determining section 107 has determined that the target file, etc. cannot be transceived before exhaustion of the battery 104 based on the amount of data R3 capable of being transceived. This avoids an interruption of data communications thereby eliminating the user's workload and a drop in the use efficiency of communications circuits caused by retried communications of the target file. Data transmission following automatic data compression improves the convenience of the user.

In this embodiment, the communications controller 108 requests the sending party to perform data compression of a target file, etc. and send the data-compressed file when the transceiving availability determining section 107 has determined that the target file, etc. cannot be received before exhaustion of the battery 104 based on the amount of data R3 capable of being transceived. This avoids an interruption of data communications thereby eliminating the user's workload and a drop in the use efficiency of communications circuits caused by retried communications of the target file. By requesting the sending party to automatically perform data compression, it is possible to improve the convenience of the user.

In this embodiment, the charger 102 starts recharging of the battery 104 when the transceiving availability determining section 107 has determined that a target file, etc. cannot be transceived before exhaustion of the battery 104 based on the amount of data R3 capable of being transceived. The transceiving availability determining section 107 obtains the amount of data R3 capable of being transceived during recharging and the operating state reporting section 109 reports the amount of data R3 capable of being transceived. This avoids an interruption of data communications thereby eliminating the user's workload and a drop in the use efficiency of communications circuits caused by retried communications of a target data group. The amount of data which can be transceived is reported to the user as required during recharging. This improves the convenience of the user. The transceiving availability determining section 107 references the charging characteristics table TB2 in the storage section 105 to perform temperature-based correction of the remaining operating time R1. This obtains a more precise amount of data R3 capable of being transceived.

In this embodiment, the communications controller 108 reduces the transmitting power of the communication apparatus 100 to allow communications when the transceiving availability determining section 107 has determined that a target file, etc. cannot be transceived before exhaustion of the battery 104 based on the amount of data R3 capable of being transceived. This avoids an interruption of data communications thereby eliminating the user's workload and a drop in the use efficiency of communications circuits caused by retried communications of the target file, etc.

In this embodiment, the communications controller 108 selects a communications system with the minimum current consumption to perform communications when the transceiving availability determining section 107 has determined that a target file, etc. cannot be transceived before exhaustion of the battery 104 based on the amount of data R3 capable of being transceived. In case communications controller 108 detects a plurality of communications systems with the minimum current consumption, it selects a communications system with the highest transfer speed. This avoids an interruption of data communications thereby eliminating the user's workload and a drop in the use efficiency of communications circuits caused by retried communications of the target file, etc.

In this embodiment, the communications controller 108 suspends communications and performs data compression of a target file, etc., recharging of the battery, reduction of transmitting power or selection of a communications system with the minimum current consumption, and restarts communications when the transceiving availability determining section 107 has determined that a target file, etc. cannot be transceived before exhaustion of the battery 104 based on the amount of data R3 capable of being transceived. Thus it is not necessary to resend the target file, etc., thereby eliminating the user's workload and a drop in the use efficiency of communications circuits as well as improving the convenience of the user.

Finally, the configurations of the invention (excluding those defined in the aspects of the invention) drawn from the embodiment will be summarized below.

(1) communication apparatus according to the first aspect of the invention, characterized in that the communication apparatus comprises storage means for retaining variations in the driving duration of the battery caused by the ambient temperature of the communication apparatus and that the transceiving availability determining means references the discharge characteristics correction table to perform temperature-based correction of the remaining operating time.

(2) communication apparatus according to the first, second, third or fourth aspect of the invention or (1), characterized in that the communication apparatus comprises compression means for compressing data and communications control means for performing data compression of a target data group on the compression means when the transceiving availability determining means has determined that the target data group cannot be transceived before exhaustion of the battery based on the amount of data which can be transceived and sending the data-compressed data group.

(3) communication apparatus according to the first, second, third or fourth aspect of the invention or (1), characterized in that the communication apparatus comprises communications control means for requesting the sending party to perform data compression of a target file, etc. and send the data-compressed file when the transceiving availability determining means has determined that a target data group cannot be received before exhaustion of the battery based on the amount of data which can be transceived.

(4) communication apparatus according to the first, second, third or fourth aspect of the invention or (1), characterized in that the communication apparatus comprises communications control means for reducing the transmitting power of the communication apparatus when the transceiving availability determining means has determined that a target data group cannot be transceived before exhaustion of the battery based on the amount of data which can be transceived.

(5) communication apparatus according to the first, second, third or fourth aspect of the invention or (1), characterized in that the communication apparatus comprises communications control means for selecting a communications system with the minimum current consumption to perform communications when the transceiving availability determining means has determined that a target data group cannot be transceived before exhaustion of the battery based on the amount of data which can be transceived.

(6) communication apparatus according to (5), characterized in that the communications control means selects a communications system with the highest transfer speed in case there are a plurality of communications systems with the minimum current consumption.

(7) communication apparatus according to the fifth or sixth aspect of the invention or (2), (3), (4), (5) and (6), characterized in that the communications control means suspends communications and performs data compression of a target file, etc., recharging of the battery, reduction of transmitting power or selection of a communications system with the minimum current consumption, and restarts communications when the transceiving availability determining means has determined that a target data group cannot be transceived before exhaustion of the battery based on the amount of data which can be transceived.

(8) A communicating method according to the seventh aspect of the invention, characterized in that the remaining operating time detecting step references a discharge characteristics correction table storing variations in the driving duration of the battery caused by the ambient temperature of the communication apparatus to perform temperature-based correction of the remaining operating time.

(9) A communicating method according to the seventh aspect of the invention or (8), characterized in that the communicating method comprises a transceiving availability determining step of determining whether a target data group can be transceived before exhaustion of the battery based on the amount of data which can be transceived before data transmission or reception and that the reporting step reports the determined result of transceiving availability by the transceiving availability determining step.

(10) A communicating method according to the seventh aspect of the invention or (8), characterized in that the communicable data amount detecting step obtains the amount of data which can be transceived during transmission or reception of a target data group and that the reporting step reports the progress of the transmission or reception procedure and the amount of data which can be transceived.

(11) A communicating method according to the seventh aspect of the invention or (8), (9) and (10), characterized in that the communicating method comprises a communications control step of suspending communications when the transceiving availability determining step has determined that a target data group cannot be transceived before exhaustion of the battery based on the amount of data which can be transceived and that the reporting step reports that communications will be suspended and the reason for the suspension.

(12) A communicating method according to the seventh aspect of the invention or (8), (9), (10) and (11), characterized in that the communicating method comprises a compressing step of compressing data and a communications control step of performing data compression by way of the compressing step and sending the data-compressed data group when the transceiving availability determining step has determined that a target data group cannot be transceived before exhaustion of the battery based on the amount of data which can be transceived.

(13) A communicating method according to the seventh aspect of the invention or (8), (9), (10) and (11), characterized in that the communicating method comprises a communications control step of requesting the sending party to perform data compression of a target data group and send the data-compressed data group when the transceiving availability determining step has determined that the target data group cannot be transceived before exhaustion of the battery based on the amount of data which can be transceived.

(14) A communicating method according to the seventh aspect of the invention or (8), (9), (10), (11), (12) and (13), characterized in that the communicating method comprises a recharging step of recharging the battery when the transceiving availability determining step has determined that a target data group cannot be transceived before exhaustion of the battery based on the amount of data which can be transceived and that the reporting step reports the amount of data which can be transceived.

(15) A communicating method according to the seventh aspect of the invention or (8), (9), (10) and (11), characterized in that the method comprises a communications control step of referencing the charging characteristics correction table storing variations in the charging amount of the battery caused by the ambient temperature of the communication apparatus during recharging of the battery to perform temperature-based correction of the remaining operating time.

(16) A communicating method according to the seventh aspect of the invention or (8), (9), (10) and (11), characterized in that the communicating method comprises a communications control step of reducing the transmitting power of the communication apparatus when the transceiving availability determining step has determined that a target data group cannot be transceived before exhaustion of the battery based on the amount of data which can be transceived.

(17) A communication apparatus according to the seventh aspect of the invention or (8), (9), (10) and (11), characterized in that the communicating method comprises a communications control step of selecting a communications system with the minimum current consumption to perform communications when the transceiving availability determining step has determined that a target data group cannot be transceived before exhaustion of the battery based on the amount of data which can be transceived.

(18) A communication apparatus according to (17), characterized in that the communications control step selects a communications system with the highest transfer speed in case there are a plurality of communications systems with the minimum current consumption.

(19) A communication apparatus according to (12), (13), (14), (15), (16), (17) and (18), characterized in that the communications control step suspends communications and performs data compression of a target file, etc., recharging of the battery, reduction of transmitting power or selection of a communications system with the minimum current consumption, and restarts the communications when the transceiving availability determining step has determined that a target data group cannot be transceived before exhaustion of the battery based on the amount of data which can be transceived.

(20) A communications program recorded as a program used to instruct a computer to execute the communicating method according to (8), (9), (10), (11), (12), (13), (14), (15), (16), (17), (18) and (19).

(21) A computer-readable recording medium where a communicating method according to (8), (9), (10), (11), (12), (13), (14), (15), (16), (17), (18) and (19) is recorded as a program to be executed by a computer.

Respective actions and advantages of the listed configurations of the invention will be summarized below.

In the communication apparatus according to (1), the communicating method according to (8), the communications program according to (20) and the recording medium according to (21), it is preferable to retain as a discharge characteristics correction table the variations in the driving duration of a battery caused by the ambient temperature of the communication apparatus on the storage means and reference the discharge characteristics correction table to perform temperature-based correction of the remaining operating time by way of the transceiving availability determining means (remaining operating time detecting step). This obtains a more precise amount of data which can be transceived.

In the communicating method according to (9), the communications program according to (20) and the recording medium according to (21), the transceiving availability determining step determines whether a target data group can be transceived before exhaustion of the battery based on the amount of data which can be transceived before data transmission or reception and the reporting step reports the determined result of transceiving availability. In this way, the determined result of the transceiving availability of the target data group which is based on the amount of data which can be transceived is reported to the user. This avoids an interruption of data communications due to exhaustion of a battery thereby eliminating the user's workload and a drop in the use efficiency of communications circuits caused by retried communications of the target data group.

In the communicating method according to (10), the communications program according to (20) and the recording medium according to (21), the communicable data amount detecting step determines amount of data which can be transceived during transmission or reception of a target data group and the reporting step reports the progress of the transmission or reception procedure the amount of data which can be transceived. In this way, the progress of the transmission or reception procedure and the amount of data which can be transceived are reported to the user as required for the user to properly determine whether the target data group can be transceived thus improving the convenience of the user.

In the communicating method according to (11), the communications program according to (20) and the recording medium according to (21), the communications control step suspends communications and the reporting step reports that communications will be suspended and the reason for the suspension when the transceiving availability determining step has determined that a target data group cannot be transceived before exhaustion of the battery based on the amount of data which can be transceived. By suspending communications before communicating the target data group, it is possible to avoid an interruption of data communications due to exhaustion of a battery thereby eliminating the user's workload and a drop in the use efficiency of communications circuits caused by retried communications of the target data group.

In the communication apparatus according to (2), the communicating method according to (12), the communications program according to (20) and the recording medium according to (21), the communications control means (communications control step) performs data compression of a target data group by way of the compressing means (compressing step) to send the data-compressed data group when the transceiving availability determining means (transceiving availability determining step) has determined that the target data group cannot be transceived before exhaustion of the battery based on the amount of data which can be transceived. In this way, data compression is performed to allow data transmission when transmission of the target data group is determined unavailable. This avoids an interruption of data communications thereby eliminating the user's workload and a drop in the use efficiency of communications circuits caused by retransmission of the target data group. The target data group automatically undergoes data compression before it is sent. This improves the convenience of the user.

In the communication apparatus according to (3), the communicating method according to (13), the communications program according to (20) and the recording medium according to (21), the communications control means (communications control step) requests the sending party to perform data compression of a target data group and send the data-compressed data group when the transceiving availability determining means (transceiving availability determining step) has determined that the target data group cannot be transceived before exhaustion of the battery based on the amount of data which can be transceived. In this way, the sending party is requested to perform data compression to allow data reception when reception of the target data group is determined unavailable. This avoids an interruption of communications during data reception thereby eliminating the user's workload and a drop in the use efficiency of communications circuits caused by retried reception of the target data group. The sending party is automatically requested to perform data compression. This improves the convenience of the user.

In the communicating method according to (14), the communications program according to (20) and the recording medium according to (21), the recharging step starts recharging of the battery when the transceiving availability determining step has determined that a target data group cannot be transceived before exhaustion of the battery based on the amount of data which can be transceived. In this practice, the communicable data amount detecting step obtains the amount of data which can be transceived during recharging by the recharging step. In this way, the battery is recharged to allow communications when communications of the target data group are determined unavailable. This avoids an interruption of data communications thereby eliminating the user's workload and a drop in the use efficiency of communications circuits caused by retried communications of the target data group. The amount of data which can be transceived is reported as required during recharging. This improves the convenience of the user.

In the communicating method according to (15), the communications program according to (20) and the recording medium according to (21), variations in the charging amount caused by the ambient temperature of the communication apparatus during recharging of the battery is stored as a charging characteristics correction table in the storage means and the remaining operating time detecting step references the charging characteristics correction table to perform temperature-based correction of the remaining operating time. This obtains a more precise amount of data which can be transceived.

In the communication apparatus according to (4), the communicating method according to (16), the communications program according to (20) and the recording medium according to (21), the communications control means (communications control step) reduces the transmitting power of the communication apparatus when the transceiving availability determining means (transceiving availability determining step) has determined that a target data group cannot be transceived before exhaustion of the battery based on the amount of data which can be transceived. In this way, the transmitting power is reduced to allow communications when communications of the target data group are determined unavailable. This avoids an interruption of data communications thereby eliminating the user's workload and a drop in the use efficiency of communications circuits caused by retried communications of the target data group.

In the communication apparatus according to (5) and (6), the communicating method according to (17) and (18), the communications program according to (20) and the recording medium according to (21), the communications control means (communications control step) selects a communications system with the minimum current consumption to perform communications when the transceiving availability determining means (transceiving availability determining step) has determined that a target data group cannot be transceived before exhaustion of the battery based on the amount of data which can be transceived. The communications control means (communications control step) selects a communications system with the highest transfer speed in case there are a plurality of communications systems with the minimum current consumption. In this way, a communications system with the minimum current consumption is selected and a communications system with the highest transfer speed is selected to allow communications when communications of the target data group are determined unavailable. This avoids an interruption of data communications thereby eliminating the user's workload and a drop in the use efficiency of communications circuits caused by retried communications of the target data group.

In the communication apparatus according to (7), the communicating method according to (19), the communications program according to (20) and the recording medium according to (21), the communications control means (communications control step) suspends communications and performs data compression of the target group, recharging of the battery, reduction of transmitting power or selection of a communications system with the minimum current consumption, and restarts communications when the transceiving availability determining means (transceiving availability determining step) has determined that a target data group cannot be transceived before exhaustion of the battery based on the amount of data which can be transceived. In this way, communications are suspended and a measure to allow communications is taken then communications are restarted. This eliminates the need to communicate the target data group from the beginning as well as the user's workload and a drop in the use efficiency of communications circuits, thereby improving the convenience of the user.

While the invention has been described in details and in terms of its preferred embodiment, those skilled in the art will recognize that various changes and modifications can be made in it without departing from the spirit and scope thereof.

This patent is based on the Japanese Patent Application filed Jul. 13, 2001 (Japanese Patent Application No. 2001-213464), the disclosure of which is incorporated herein by reference.

### INDUSTRIAL APPLICABILITY

As described hereinabove, according to the communication apparatus, the communicating method, the communications program and the recording medium of this invention, the battery level detecting means (battery level detecting step) detects the level of the battery, the transceiving availability determining means obtains the remaining operating time up to shutdown of the communication apparatus due to exhaustion of the battery (by way of the remaining operating time detecting step) based on the level of the battery detected and obtains the amount of data which can be transceived by the communication apparatus before exhaustion of the battery (by way of the communicable data amount detecting step) based on the remaining operating time, and the reporting means (reporting step) reports the amount of data which can be transceived. This allows the user to properly determine whether the target data group can be transceived.

According to the invention, the transceiving availability determining means determines whether a target data group can be transceived before exhaustion of the battery based on the amount of data which can be transceived before data transmission or reception and the reporting means reports the determined result of the transceiving availability. This avoids an interruption of data communications due to exhaustion of a battery thereby eliminating the user's workload and a drop in the use efficiency of communications circuits caused by retried communications of the target data group.

According to the invention, the transceiving availability determining means determines whether the target data group can be transceived before exhaustion of the battery based on the amount of data which can be transceived before data transmission or reception and the reporting means reports the determined result of the transceiving availability. This avoids an interruption of data communications due to exhaustion of a battery thereby eliminating the user's workload and a drop in the use efficiency of communications circuits caused by retried communications of the target data group.

Further, according to the invention, the transceiving availability determining means obtains the amount of data which can be transceived during transmission or reception of a target data group and the reporting means reports the progress of the transmission or reception procedure and the amount of data which can be transceived. This allows the user to determine whether the target data group can be transceived thus improving the convenience of the user.

1. A communication apparatus driven by a battery, comprising:
battery level detecting means for detecting a level of said battery;
transceiving availability determining means for obtaining a remaining operating time up to shutdown of the communication apparatus due to exhaustion of said battery based on the level of the battery detected by said battery level detecting means and obtaining the amount of data which can be transceived by the communication apparatus before exhaustion of said battery based on the remaining operating time, and
reporting means for reporting said amount of data which can be transceived.

2. The communication apparatus according to claim 1,
wherein said transceiving availability determining means determines whether a target data group can be transceived before exhaustion of said battery based on said amount of data which can be transceived in sending or receiving data, and
wherein said reporting means reports a determined result of the transceiving availability by said transceiving availability determining means.

3. The communication apparatus according to claim 1,
wherein said transceiving availability determining means obtains said amount of data which can be transceived during transmission or reception of a target data group, and
wherein said reporting means reports the progress of said transmission or reception procedure and said amount of data which can be transceived.

4. The communication apparatus according to claim 1, 2 or 3, further comprising:
communications control means for suspending communications when said transceiving availability determining means determined that a target data group cannot be transceived before exhaustion of said battery based on said amount of data which can be transceived;
wherein said reporting means reports suspension of transceiving and a reason for the suspension.

5. The communication apparatus according to claim 1, 2, 3 or 4,
wherein said transceiving availability determining means starts recharging of said battery and obtains said amount of data which can be transceived during recharging when said determining means determines that a target data group cannot be transceived before exhaustion of said battery based on said amount of data which can be transceived, and
wherein said reporting means reports said amount of data which can be transceived.

6. The communication apparatus according to claim 5, further comprising:
storage means for retaining as a charging characteristics correction table the variations in the charging amount caused by the ambient temperature of said communication apparatus during recharging of said battery;
wherein said transceiving availability determining means references the charging characteristics correction table to perform temperature-based correction of said remaining operating time.

7. A communicating method for a communication apparatus driven by a battery, said method comprising the steps of:
a battery level detecting for detecting the level of said battery;
a remaining operation time detecting for detecting a remaining operation time up to shutdown of the communication apparatus due to exhaustion of said battery based on the level of the battery detected by said battery level detecting step;
a communicable data amount detecting for obtaining the amount of data which can be transceived by the communication apparatus before exhaustion of said battery based on said remaining operating time; and
a reporting for reporting said amount of data which can be transceived.

8. A communications program for causing a computer to execute the communicating method according to claim 7.

9. A computer-readable recording medium recorded as a program for causing a computer to execute the communicating method according to claim 7.
